(19) United States
(12) Patent Application Publication
(10) Pub. No.: US 2026/0326490 A1
(43) Pub. Date: Oct. 22, 2026

(54) CHASSIS FOR A UTILITY VEHICLE

(71) Applicants: Abdullah JABER, Aachen (DE); Raid MAZYEK, Stolberg (DE); Helko MUES, Aachen (DE); Tobias KRIEG, Wallenhorst-Lechting (DE); Andreas KRÖGER, Lohne (DE); Dirk ZUMDOHME, Löningen (DE); Trailer Dynamics GMBH, Eschweiler (DE)

(72) Inventors: Abdullah JABER, Aachen (DE); Raid MAZYEK, Stolberg (DE); Helko MUES, Aachen (DE); Tobias KRIEG, Wallenhorst-Lechting (DE); Andreas KRÖGER, Lohne (DE); Dirk ZUMDOHME, Löningen (DE)

(73) Assignee: Trailer Dynamics GMBH, Eschweiler (DE)

(21) Appl. No.: 19/109,801

(22) PCT Filed: Sep. 7, 2023
(86) PCT No.: PCT/EP2023/074625

§ 371 Date: Mar. 7, 2025

(30) Foreign Application Priority Data
Sep. 9, 2022 (DE) 10 2022 123 039.2

(51) Int. Cl. B60G 7/00; B62D 21/20; B62D 53/06; B62D 65/12

(52) U.S. Cl. CPC B60G 7/008; B62D 21/20; B62D 53/06; B62D 65/12; B60G 2200/422; B60G 2204/148; B60G 2204/421; B60G 2300/042

(57) ABSTRACT

The invention relates to a chassis for a utility vehicle, said chassis having a control arm (8) with a mounting for attaching an axle element to the control arm (8). The aim of the invention is to allow the chassis to be adapted to different requirements in a simple manner. This is achieved in that the mounting is designed as a connecting piece (20) which has a flange surface (22) on the connecting piece side facing a wheel carrier (12), said flange surface being used to connect the connecting piece (20) to the wheel carrier (12) via a flange connection.

The present invention relates to a chassis for a commercial vehicle according to the preamble of claim 1, and to a commercial vehicle having a corresponding chassis according to the preamble of claim 10.

The document DE 10 2014 218 328 A1 discloses an axle unit in which an axle stub is connected to an axle tube via a cross member. The purpose of this structure is to make it possible to supply the axle stub better with a hydraulic fluid.

The document DE 10 2011 086 480 A1 discloses an axle unit for a commercial vehicle, in which a first and a second axle element are fastened to a linkage element. The linkage element has a connecting piece via which it is connected to the second axle element. Since the second axle element is in the form of a stub axle and is connected to the linkage element in a manner spatially offset with respect to the first axle element, the overall height and the weight of the axle system can be reduced.

The document DE 10 2006 015 671 A1 discloses a vehicle axle body having two control arms, on the outside of which wheel carriers for mounting the vehicle wheels are placed. The control arms are wider and taller in the attachment region of the wheel carriers in order to form a connecting piece there. The respective vehicle wheels are mounted on the wheel carriers. The wheel carriers are welded from the outside against a corresponding seat of the trailing arm.

The demands placed on chassis of commercial vehicles are becoming more complex, since the chassis need to be adapted increasingly stringently to the specific use purpose of a commercial vehicle. Thus, both drum brakes and disk brakes are installed on commercial vehicles, in addition to hydraulic drives, electric drives have recently also been used in chassis for commercial vehicles, and wheels of different sizes and accordingly dimensioned bearings are required for different superstructures and payloads. In order to be able to cover these different demands, specialized axles have to be produced for each application.

The present invention addresses the problem of creating a chassis for commercial vehicles which makes it possible to adapt the chassis in a simple manner to different demands.

The problem is solved for a chassis of the type in question by the characterizing features of claim 1 and for the commercial vehicle of the type in question by the characterizing features of claim 10.

The flange surfaces forms an interface between a control arm and a wheel carrier. While the control arms can remain the same for different demands placed on the commercial vehicle, it is possible to cover the different demands placed on the chassis for commercial vehicles by differently designed wheel heads. Thus, wheel heads can be connected to the control arm, which, as required, do not have a separate drive or which are provided with a hydraulic, mechanical or electric drive, wherein the drive outputs may also differ from one another and may require a different design of the components. Transmission gears and reduction gears may also be provided in the wheel heads. The different wheel heads may also be provided with different brake systems and/or differently dimensioned bearings. The different wheel heads form a type of construction kit, via which a commercial vehicle, in particular a truck trailer, can be provided individually with the components with which a customer wishes to have their trailer equipped.

Compared with the previously known welded connections, the flange connection results in the advantage that the component connection can be established quickly and cost-effectively, but also in a highly loadable manner. Assembly advantages arise from the circumstance that, in the connecting zone during assembly, no welding distortions occur. Also, after the assembly of a wheel carrier, no deburring and repainting work is required in the connecting zone. Finally, as a result of the flange connection, any repair work that may become necessary is made considerably easier.

The connecting piece may be formed in principle in a desired and suitable manner. The connecting piece may be formed in a side wall of the control arm, for example by being formed in a particular way or by way of a flange plate which is connected to the control arm. In this case, the flange plate can be formed in one or more parts. It has a suitable shape compatible with the complementary contact surface of the wheel carrier. The connecting piece may also be formed from a sheet-metal or welded assembly which is placed on the control arm and connected firmly thereto. Formed in the material of the connecting piece are passage openings through which bolts can be passed, via which the control arm is connected to a wheel carrier.

The control arms may be embodied in one or more parts. In the case of a one-part embodiment, they extend as a welded assembly or as a single component cast as a steel casting from the pivot bearing into the region of the attachment of the axle bridge. In the case of a multi-part embodiment, there are divisions between the individual parts of the control arms, at which divisions the individual parts are joined together to form a control arm, however.

According to one refinement of the invention, the connecting piece is in the form of a tubular connecting section. On account of their shape, tubes are very strong with respect to acting loads. The connecting piece may in particular be a portion of a cylindrical tube. They are therefore readily suitable for transmitting the forces that act on the wheels while the commercial vehicle is being driven to the control arm and via the latter to the frame of the commercial vehicle. Tubes are also easy to procure as semifinished products and can be cut to an appropriate length with little effort. An end face of a tube used as a connecting section can serve to form the flange surface thereon. To this end, the end face of the tube can be formed in a suitable manner and/or be provided with a separate component which serves as a flange surface. In another section, it is possible, for example, for the lateral surface or the end face of the tube to be welded to adjoining components of the control arm or to be connected thereto in some other way. When a tube is used as the connecting piece, the additional advantage arises that this tube adjoins, with its tube wall, a cavity which can be used to pass shafts, cables and other lines through it in order to connect the wheel carrier to a mechanical, electric, hydraulic or pneumatic drive source and/or to transmit electrical signals, for example the signals from temperature and/or speed and/or wear sensors or control commands to actuators which are located in the wheel carrier.

According to one refinement of the invention, the flange surface is in the form of a flange ring which engages around the outside of the connecting piece. A flange ring is a cost-effective and proven method for connecting highly loaded components together in a reliable and durable manner. When a flange ring engages around the outside of the connecting piece, the passage openings into which the bolts for connecting the wheel carrier to the control arm are inserted are readily accessible from the outside during assembly.

According to one refinement of the invention, the wheel carrier has an axle stub which is placed on the connecting piece and the flange surface on the wheel side of the control arm, and a wheel bearing is mounted on the outer circumference of the axle stub. The axle stub carries the wheel bearing and transmits the forces that act on the wheel in question during driving to the control arm. The axle stub has a suitable length and dimensions. It can be embodied in a solid or hollow manner on the inside.

According to one refinement of the invention, the axle stub has, on its side facing the control arm, a protrusion which, in the mounted position of the axle stub, projects into a cavity which is formed in the connecting piece, wherein the outwardly facing surface of the protrusion bears in a form-fitting manner on the adjacent inner surface of the cavity and as a result the axle stub is supported in a position centering manner on the inner wall of the connecting piece. As a result of the protrusion, the contact surface on which the axle stub and the connecting piece are in contact with one another is enlarged. As a result, greater forces can be transmitted and the force transmission between the components is not restricted just to the flange surface. The protrusion may be formed in particular in an annular manner resulting in better support around the entire circumference of the axle stub.

According to one refinement of the invention, the connecting piece has, on its outer circumference, a shaping which, when the control arm is assembled with the connecting piece, ensures that the connecting piece is positioned precisely on the control arm and that the connecting piece and the side plate of the control arm are connected in a form-fitting manner. This makes assembly easier and the form-fitting connection ensures that the other connection between the connecting piece and control arm is relieved of load.

According to one refinement of the invention, the axle stub internally has a cavity which extends along the length of the axle stub. The cavity may be open at its end faces or be sealed off by an appropriate seal. The cavity in the axle stub may be used to pass shafts, cables and other lines through it in order to supply the wheel carrier with a mechanical, electric, hydraulic or pneumatic drive source and/or to transmit electrical signals, for example the signals from temperature and/or speed and/or wear sensors or control commands to actuators which are located in the wheel carrier.

According to one refinement of the invention, a driveshaft passes through the cavity in the axle stub, said driveshaft protruding, at the wheel-side end face of the cavity, beyond the wheel-side end of the axle stub and being connected to a wheel there via an output. The output may be embodied for example as a cardan shaft. The wheel body having a hollow axle stub through a driveshaft passes allows the wheel fastened to the wheel body to be mechanically driven. In this way, the chassis for a commercial vehicle can be provided with a separate drive. The drive motor and/or gears or differentials belonging to the drive can, in this case, be arranged in particular beneath the frame of the commercial vehicle in a region between the control arms.

According to one refinement of the invention, the driveshaft is supported by a bearing which is arranged in the cavity formed in the connecting piece. As a result of the sole or additional support of the driveshaft via a bearing which is arranged in the cavity formed in the connecting piece, the driveshaft can be run very smoothly. Since the bearing is moved up and down together with the connecting piece during deflection or rebounding movements of the chassis, the driveshaft is always kept in a spatially appropriate position with respect to the driven wheel. As a result, the drive is also very reliable. The bearing at the end of the driveshaft is also capable of absorbing forces and vibrations that arise on account of shafts attached on the drive side, and thus of protecting the driveshaft from excessive stress.

It is noted that the refinements of the invention that are set out above can each be combined separately, but also among one another with the subject matter of claim 1 and the remaining dependent claims, as long as this is not prevented by any technical obstacles and there are no obligatory dependences.

Further modifications and refinements of the invention can be gathered from the claims, the description and the drawings.

The invention will be explained in more detail in the following text with reference to an exemplary embodiment. In the figures:

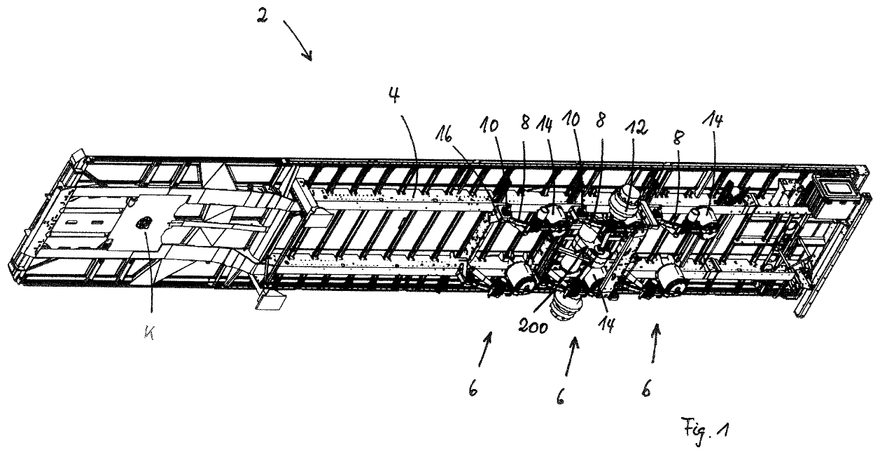

FIG. 1: shows an overall view, obliquely from below, of an electric drive train installed in a commercial vehicle,

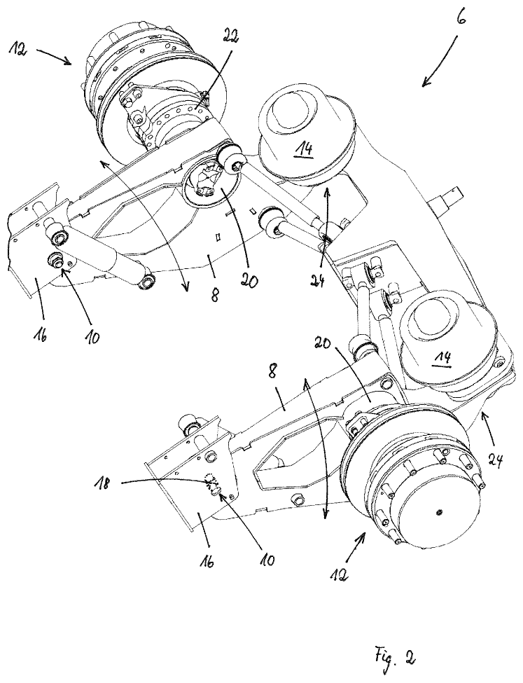

FIG. 2: shows an enlarged view of a chassis in a perspective view obliquely from above,

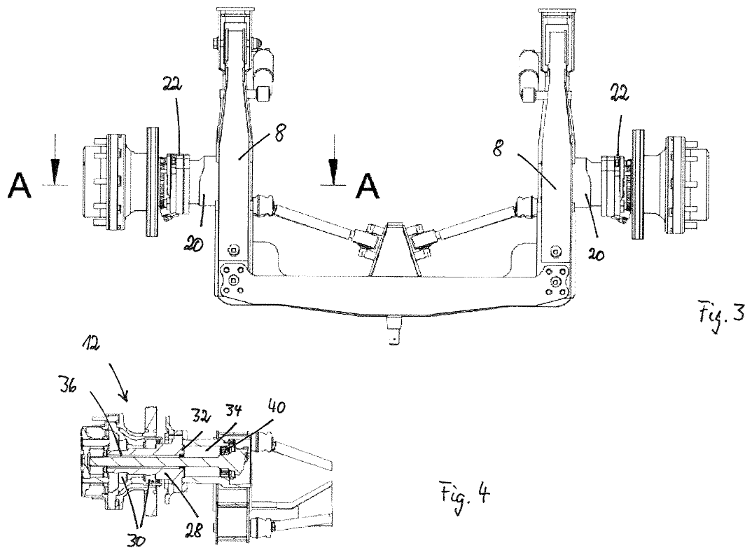

FIG. 3: shows a bottom view of the chassis, and

FIG. 4: shows a sectional view along the line A-A in FIG. 3.

FIG. 1 shows an overall view, obliquely from below, of a commercial vehicle 2 in the form of a truck trailer, in which an electric drive train 200 is installed. The commercial vehicle 2 has a vehicle frame 4, which is supported on the ground via three axle structures 6 in the exemplary embodiment. The central axle structure 6 has the electric drive train 200, and the axle bridge and axle have been omitted from the two other axle structures 6 in order to simplify the drawing. In the front region, the commercial vehicle 2 is placed by way of the kingpin K on the semitrailer coupling of a semitrailer truck (not illustrated in more detail in the drawing) and hauled via the latter.

The chassis 6 each have, on opposite sides of the vehicle frame 4, a control arm 8, each of which is connected to the vehicle frame 4 via a pivot bearing 10 arranged in a retaining device 16. Also fastened to each control arm 8 is a wheel carrier 12, on which the wheels of the commercial vehicle 2 can then be screwed. At their end remote from the pivot bearing 10, the control arms 8 are also each supported on the vehicle frame 4 via a spring element 14. The control arms 8 thus rotate about the pivot bearing 10 in the event of spring movements and spring counter to the restoring forces in the flexible spring elements 14.

Die FIG. 2 shows an enlarged view of a chassis 6 in a perspective view obliquely from above. The control arms 8 pivot with their bearing eyes 18 about the pivot bearings 10 in the retaining devices 16, as indicated by the double arrows. As a holder for attaching an axle element to the control arms 8, connecting pieces 20 are arranged on the control arms 8 at a first distance from the bearing eye 18. At a second distance from the bearing eye 18, a support section 24 for connecting the control arm 8 is a spring element 14 is formed.

The connecting pieces 20 have, on their respective side facing a wheel carrier 12, a flange surface 22 via which the connecting piece 20 is connected to the wheel carrier 12 via a flange connection. The wheel carrier 12 forms in this regard an axle element within the meaning of the invention. The connecting piece 20 is in the form of a tubular connecting section. The flange surface 22 is in the form of a flange ring which engages around the outside of the connecting piece 20.

FIG. 3 shows a bottom view of the chassis 6. In this view, it is apparent that the connecting pieces 20 protrude outwardly from the control arms 8. The flange surfaces 22 are designed to extend annularly around the connecting pieces 20. In the exemplary embodiment, the control arms 8 are connected together by an axle bridge 26. The axle bridge 26 connects the control arms 8 in the region of the support section 24.

In FIG. 4, which shows a sectional view along the line A-A in FIG. 3, it is apparent that the wheel carrier 12 has an axle stub 28 which is placed on the connecting piece 20 and the flange surface 22 on the wheel side of the control arm 8, and a wheel bearing 30 is mounted on the outer circumference of the axle stub 28.

The axle stub 28 has, on its side facing the control arm 8, a protrusion 32 which, in the mounted position of the axle stub 28, projects into a cavity 34 which is formed in the connecting piece 20, wherein the outwardly facing surface of the protrusion 32 bears in a form-fitting manner on the adjacent inner surface of the cavity 34 and as a result the axle stub 28 is supported in a position centering manner on the inner wall of the connecting piece 20.

In addition, the axle stub 28 internally has a cavity 36 which extends along the length of the axle stub 28. The cavity 36 may be embodied in an open manner at its end faces. A driveshaft 38 passes through the cavity 36 in the axle stub 28, said driveshaft protruding, at the wheel-side end face of the cavity 36, beyond the wheel-side end of the axle stub 28 and being connected to a wheel there via an output. The driveshaft 38 is supported by a bearing 40 which is arranged in the cavity 34 formed in the connecting piece 20.

The invention is not restricted to the above-described exemplary embodiment. A person skilled in the art will have no difficulty in modifying the exemplary embodiment in a manner that appears to be suitable to them in order to adapt it to a specific application.

### LIST OF REFERENCE SIGNS

2 Commercial vehicle
4 Vehicle frame
6 Chassis
8 Control arm
10 Pivot bearing
12 Wheel carrier
14 Spring element
16 Retaining device
18 Bearing eye
20 Connecting piece
22 Flange surface
24 Support section
26 Axle bridge
28 Axle stub
30 Wheel bearing
32 Protrusion
34 Cavity
36 Cavity
38 Driveshaft
40 Bearing
200 Electric drive train
K Kingpin

1. A chassis (6) for a commercial vehicle (2), having a control arm (8) which has at a first end a bearing eye (18) for pivotably mounting the control arm (8) in a retaining device (16) on the frame, at a first distance from the bearing eye (18) a holder for attaching an axle element to the control arm (8), and at a second distance from the bearing eye (18) a support section (24) for connecting the control arm (8) to a spring element (14), characterized in that the holder is in the form of a connecting piece (20) which has on its side facing a wheel carrier (12) a flange surface (22) via which the connecting piece (20) is connected to the wheel carrier (12) via a flange connection.

2. The chassis (6) as claimed in claim 1, characterized in that the connecting piece (20) is in the form of a tubular connecting section.

3. The chassis (6) as claimed in claim 1, characterized in that the flange surface (22) is in the form of a flange ring which engages around the outside of the connecting piece (20).

4. The chassis (6) as claimed in claim 1, characterized in that the wheel carrier (12) has an axle stub (28) which is placed on the connecting piece (20) and the flange surface (22) on the wheel side of the control arm (8), and a wheel bearing (30) is mounted on the outer circumference of the axle stub (28).

5. The chassis (6) as claimed in claim 4, characterized in that the axle stub (28) has, on its side facing the control arm (8), a protrusion (32) which, in the mounted position of the axle stub (28), projects into a cavity (34) which is formed in the connecting piece (20), wherein the outwardly facing surface of the protrusion (32) bears in a form-fitting manner on the adjacent inner surface of the cavity (34) and as a result the axle stub (28) is supported in a position centering manner on the inner wall of the connecting piece (20).

6. The chassis (6) as claimed in claim 4, characterized in that the connecting piece (20) has, on its outer circumference, a shaping which, when the control arm (8) is assembled with the connecting piece (20), ensures that the connecting piece (20) is positioned precisely on the control arm (8) and that the connecting piece (20) and the side plate of the control arm (8) are connected in a form-fitting manner.

7. The chassis (6) as claimed in any of claim 4, characterized in that the axle stub (28) internally has a cavity (36) which extends along the length of the axle stub (28), wherein the cavity (36) is open at its end faces.

8. The chassis (6) as claimed in claim 7, characterized in that a driveshaft (38) passes through the cavity (36) in the axle stub (28), said driveshaft protruding, at the wheel-side end face of the cavity (36), beyond the wheel-side end of the axle stub (28) and being connected to a wheel there via an output.

9. The chassis (6) as claimed in claim 8, characterized in that the driveshaft (38) is supported by a bearing (40) which is arranged in the cavity (34) formed in the connecting piece (20).

10. A commercial vehicle (2) having a chassis (6) with a control arm (8) which has at a first end a bearing eye (18) for pivotably mounting the control arm (8) in a retaining device (16) on the frame, at a first distance from the bearing eye (18) a connecting piece (20) for attaching an axle body to the control arm (8), and at a second distance from the bearing eye (18) a support section for connecting the control arm (8) to an air spring element, characterized in that the chassis (6) is designed as per the characterizing features of claim 1.
